(19) United States
(12) Patent Application Publication
(10) Pub. No.: US 2025/0217654 A1
(43) Pub. Date: Jul. 3, 2025

(54) DEVICE AND METHOD FOR CONFIGURING A PROCESS

(71) Applicant: Agency for Science, Technology and Research, Singapore (SG)

(72) Inventors: Chao Jin, Singapore (SG); Khin Mi Mi Aung, Singapore (SG); Saisubramaniam Gopalakrishnan, Singapore (SG); Ramanpreet Singh Pahwa, Singapore (SG); Ashish James, Singapore (SG)

(21) Appl. No.: 18/848,890

(22) PCT Filed: Mar. 7, 2023
(86) PCT No.: PCT/SG2023/050141

§ 371 Date: Sep. 19, 2024

(30) Foreign Application Priority Data
Mar. 23, 2022 (SG) 10202202948W

(51) Int. Cl. G06N 3/084; G06N 3/048; H04L 9/00; H04L 9/08

(52) U.S. Cl. CPC G06N 3/084; G06N 3/048; H04L 9/008; H04L 9/0825

(57) ABSTRACT

A method for efficiently performing a process configuration where information of multiple users may be kept secret from each other. A neural network trained to map process inputs to process outputs is converted to operate on data in the encrypted domain of a predetermined encryption and decryption scheme such that the encryption of the encryption and decryption scheme is homomorphic with respect to the operation of the converted neural network. Furthermore, a desired process output in the encrypted domain is determined. Additionally, an input in the encrypted domain to the converted neural network leading to an output of the converted neural network approximating the desired process output in the encrypted domain is determined. The determined input is then provided for configuration of the process.

### CROSS-REFERENCE TO RELATED APPLICATION

This application claims the benefit of priority of Singapore Patent Application No. 10202202948W, filed 23 Mar. 2022, the content of which being hereby incorporated by reference in its entirety for all purposes.

### TECHNICAL FIELD

Various aspects of this disclosure relate to devices and methods for configuring a process.

### BACKGROUND

In many domains ranging from science to engineering, experiments are typically conducted to characterize the inter-dependencies between products (or outputs) and the corresponding process parameters (or inputs) of a process (e.g. manufacturing process, treatment process etc.). In most cases, running such experiments is expensive (in computation resources, time, etc.), indecisive (e.g. in complex systems involving several parameters that cannot be changed in a controlled one-by-one manner), and also infeasible (e.g., in clinical medicine, where it may not be feasible to check if a new drug dose/mix has a desired effect on patient outcome as this may pose safety concerns). So, a systematic and orderly strategy is desired that maximizes the knowledge base using minimum resources. Design of experiments (DOE) is a statistical technique that can be applied in such a context to rigorously understand and characterize the impact of process variations on a product and find, for example, optimal process parameters regarding a desired output profile, i.e. for example desired characteristics of a product. However, as the complexity of the respective process grows this may take several hundreds or even thousands of experiments. This may lead to a severe bottleneck in several domains that results in high delays.

An approach to address this is issue is the usage of a data-driven approach using an artificial neural network to assist in finding suitable process inputs, i.e. a deep learning based design or configuration approach, to find the optimal process parameters for a desired output profile. This may include training a forward neural network model to map process inputs to the outputs based on existing experiment datasets, and then, given a desired experiment output, finding out the optimized input by invoking a so-called inverse process through the model.

However, a deep learning based design approach requires large amounts of experiment data to build up the forward design neural network model (which predicts process inputs to process outputs), which may be infeasible for an individual user. On the other hand, direct data sharing and collaboration between users may be prohibited due to privacy concerns. For example, process tool recipe data should usually be protected. For example, lithography manufacturers, etching machine manufacturers, deposition providers, as well as 2D-3D metrology providers may have capital intensive equipment in the same fabrication plant but the fear of intellectual property theft and industrial espionage and know-how intelligence prevent these companies to interact closely. This may result in inefficient processes that are both costly and time consuming.

Accordingly, approaches for efficiently performing process configuration where information of multiple users may be kept secret from each other are desirable.

### SUMMARY

Various embodiments concern a method for configuring a process including converting a neural network trained to map process inputs to process outputs to operate on data in encrypted domain of a predetermined encryption and decryption scheme such that the encryption of the encryption and decryption scheme is homomorphic with respect to the operation of the converted neural network, determining a desired process output in encrypted domain, determining an input in encrypted domain to the converted neural network leading to an output of the converted neural network approximating the desired process output in encrypted domain and providing the determined input for configuration of the process.

According to one embodiment, the method includes training the neural network to map process inputs to process outputs.

According to one embodiment, determining the desired process output in encrypted domain includes obtaining a desired process output and encrypting the desired process output to encrypted domain.

According to one embodiment, the method includes decrypting the determined input.

According to one embodiment, the method includes configuring the process according to the decrypted determined input.

According to one embodiment, the input in encrypted domain to the converted neural network is determined by searching for an input which minimizes the loss between the output that the converted neural network outputs in response to the input and the desired process output in encrypted domain.

According to one embodiment, the input in encrypted domain to the converted neural network is determined by performing back-propagation in the encrypted domain by utilizing polynomial approximations for computations of both the non-linear activation function computations and their gradients.

According to one embodiment, the method includes controlling a system for performing the process according to the determined input.

According to one embodiment, the process is a manufacturing process and the input specifies one or more control parameters of a manufacturing system and the method includes controlling the manufacturing system according to the determined input.

According to one embodiment, the encryption and decryption scheme is a public key encryption and decryption scheme, specifically, a levelled or fully homomorphic encryption scheme that supports computation on encrypted data without decryption key.

According to one embodiment, the method includes performing multiple iterations of determining a desired process output in encrypted domain (wherein the desired process output is for example predefined by a user and fixed during the iterative process) and determining an input in encrypted domain to the converted neural network leading to an output of the converted neural network approximating the desired process output in encrypted domain until the determined input fulfils a predetermined quality criterion and includes providing the determined input for configuration of the process when the determined input fulfils the predetermined quality criterion.

According to one embodiment, the predetermined quality criterion is that the determined input leads to an output of the converted neural network which approximates the desired process output in encrypted domain with a predetermined accuracy.

According to one embodiment, a system is provided including one or more computers, each computer including a communication interface, a memory and a processing unit, wherein the system is configured to perform the method of any one of the embodiments described above.

According to one embodiment, a computer program element is provided including program instructions, which, when executed by one or more processors, cause the one or more processors to perform the method of any one of the embodiments described above.

According to one embodiment, a computer-readable medium is provided including program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 illustrates a process configuration procedure according to various embodiments.

FIG. 2 shows an example of an architecture of a machine learning (ML) model.

FIG. 3 shows performance results of an embodiment.

FIG. 4 shows another example of an architecture of an ML model.

FIG. 5 shows performance results of an embodiment.

FIG. 6 shows a flow diagram illustrating a method for performing process configuration according to an embodiment.

FIG. 7 shows a server computer according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

According to various embodiments, a method to allow users to securely outsource process configuration without leaking information (that should be kept secret) from any one of the users to one of the other users is provided, using Fully Homomorphic Encryption (FHE). Process configuration may be understood as finding an input for a (targeted) process, in the following also referred to as target process, which achieves a certain output of the process. The input may be production parameters for a manufacturing process, a dose or type of drug for a treatment process, etc. The process may also be an experiment such that performing a process configuration (i.e. configuring a process) can be seen as a design of experiment. In general, performing a process may be also be seen as performing an experiment so for any process the process configuration may be seen as design of experiment.

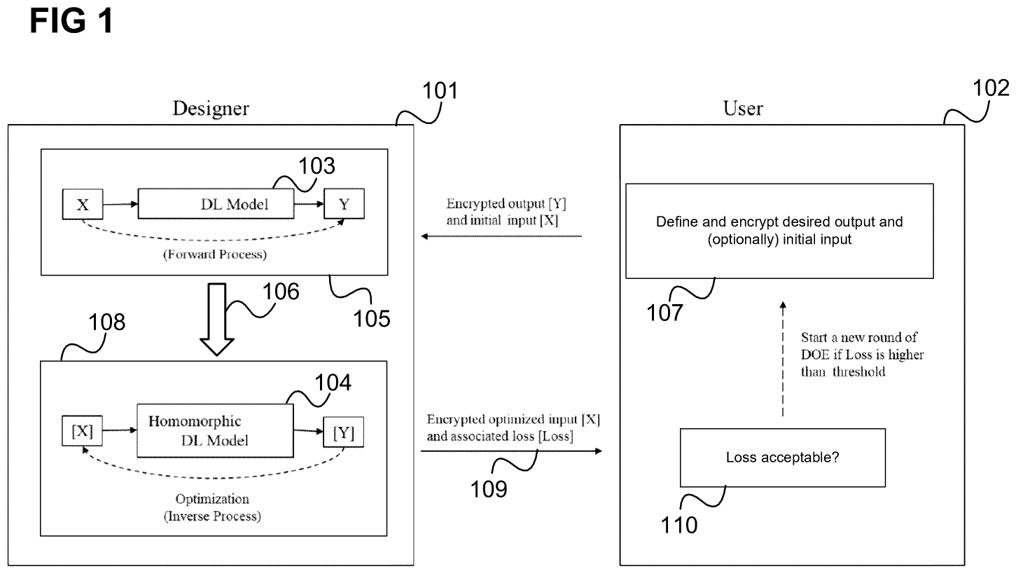

FIG. 1 illustrates a process configuration procedure, i.e. illustrates performing process configuration using FHE according to various embodiments.

The operations of the process configuration procedure include operations on designer (or server) side 101 and a user (or client) side 102. For example, the process configuration procedure is carried out by a computer system including one or more first computers performing the operations of the designer side 101 and one or more second computers performing the operations of the user side 102. However, a designer and a user may also share one or more computers such that operations of the designer side 101 and operations of the user side 102 are at least partially performed by the same one or more computers.

Furthermore, it should be noted that while only the operations of a single user are depicted, multiple users may be involved, i.e. the operations of the user side 102 may be performed for multiple users whose data should be kept secret from each other. The process configuration procedure allows the users to securely outsource the process configuration to the designer side 101.

It is assumed that on the designer side 101, knowledge on process configuration for the targeted experiments is available such that the designer (i.e. the service provider) is able to build and train, in 105, a machine learning model, e.g. a deep learning model 103 to simulate the respective process, e.g. based on previous experimental datasets. The process that is simulated may for example be a production process where inputs X are production parameters and outputs Y are product characteristics. It may also be other kinds of processes like a medical treatment process where the inputs include a dose and/or a type of medicine and the outputs include an effect of the medicine, any kind of control processes wherein the input is a control signal and the output is a result of the control etc.

It is assumed that the user wants to obtain an optimized input for a certain desired output of the simulated process.

For this, in 105, the designer builds and trains the deep learning model 103 based on available experiment data in plaintext (i.e. to operate in unencrypted domain). The deep learning model 103 is therefore also referred to a plaintext model 103.

In 106, the designer converts the plaintext model 103 into a homomorphic model 104, i.e. a model whose operations are homomorphic with respect to a predetermined encryption and decryption scheme. The operations of the model 104 being homomorphic which respect to the encryption and decryption scheme may be understood as encrypting or decrypting data and then applying the operations gives the same result as applying the operations to the data and then encrypting or decrypting the data. This holds for both the operations of a forward pass (i.e. the forward process) through the homomorphic model 104 as well as the operations of a backward pass (i.e. the backward process) through the homomorphic model 104. In other words, “homomorphic” may be understood to mean that the model 104 has the following feature: the model 104 when operating on encrypted input produces an encrypted output, and the model 104 when operating on the same plaintext input (i.e., decrypted from the previous encrypted input) produces a plaintext output, and this plaintext output is the same as the previous encrypted output when the encrypted output is decrypted.

It should be noted that equivalently, it may be said that the encryption and decryption scheme is homomorphic with respect to the model 104.

The conversion to the homomorphic model 104 and its operation may include one or more of:
a) using polynomial approximations for non-linear activation functions and their derivative computations.
b) translating the neural network computations from plaintext domain into the cipher text domain.
c) extending the backward propagation process of the homomorphic model 104 to directly optimize the inputs with gradient descent.

In 107, the user defines the desired output Y of the simulated process (or experiment). The user encrypts Y using the encryption and decryption scheme into a cipher text [Y] and provides (e.g. sends) [Y] to the designer. The user may also encrypt and send starting values for the input [X] of the homomorphic model 104 to the designer. The user may for example encrypt the desired output (and possibly input) using a public key. Furthermore, the user provides (public) evaluation information (e.g. one or more evaluation keys) to the designer.

In 108, the designer sets some initial inputs or uses user defined inputs for the homomorphic model 104 and runs the extended backward propagation process to optimize the inputs to minimize the loss between the model outputs and user desired outputs.

In 109, after running a predefined number of optimizing iterations, the designer sends the optimized inputs and the associated loss in encrypted form to the user. The user may, in 110, decrypt the optimized inputs and accept the inputs (and use them as input for the respective process) if the loss is within certain range. Otherwise, the user may re-encrypt the inputs (as starting values of a next iteration) and go back to 107 for the next iteration (i.e. round) of the process configuration procedure.

The approach of FIG. 1 provides a privacy-preserving protocol that enables secure collaboration on process configuration between the designer and the user (in particular multiple users), without leaking information between the parties (designer and user(s)).

According to various embodiments, the approach of FIG. 1 includes a general framework that enables training and inference of deep networks on both clear data and encrypted data. In particular, according to various embodiments, it enables both the non-linear activation computation in the forward process and the gradient computation in the backward process, on encrypted data through polynomial approximations. Thus, according to various embodiments, the approach of FIG. 1 provides a secure process configuration inverse process implementation on encrypted data by directly updating the inputs of the homomorphic process configuration model during backward propagation process with gradient descent.

Using an accelerated FHE Hardware Engine, for example, a critical point of data sharing in a process configuration context can thus be addressed and an efficient, safe, reliable, and fast troubleshooting workflow can be provided that enhances the productivity and security, e.g. of production process.

An implementation of the approach of FIG. 1, e.g. in software, may for example include
a) DL model training and inference on plain data types (e.g., integers and float-points) with original and customized activation functions (e.g., polynomials).
b) Private DL model training and inference on encrypted input data (e.g., FHE cipher texts).
c) A mixed way for DL model training on both plain data an encrypted data. A model can be first trained on plain data, and subsequently retrained (or fine-tuned) with encrypted data.
d) An extended backward propagation process during training which can directly optimize network inputs with gradient descent.

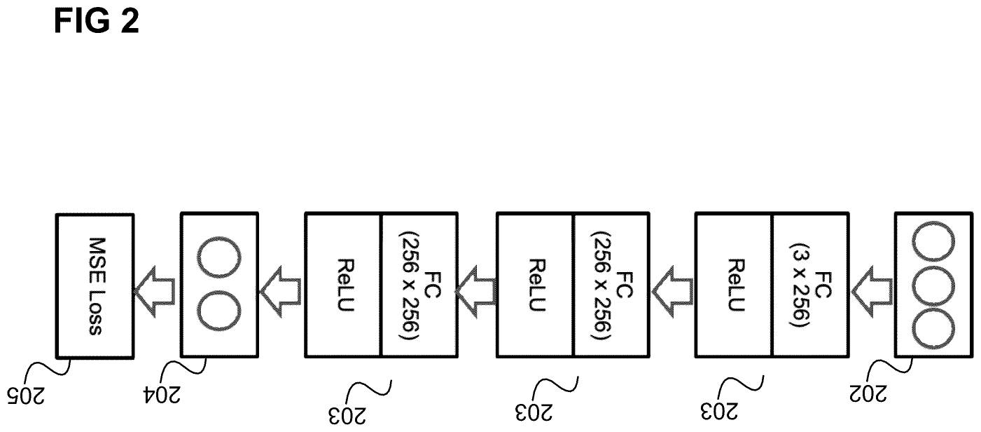

FIG. 2 shows an example of an architecture of the plaintext model 103.

An input 202 is processed by a sequence of fully connected layers 203, e.g. including ReLU activation, to an output 204.

The architecture may for example be trained using MSE (mean squared error) loss 205, e.g., for a semiconductor manufacturing application, using a PNR (placement and routing) data set. The training may in this case be done directly with polynomial activation functions.

Training of a model with the architecture of FIG. 2 for the PNR dataset gives an MSE Loss on the PNR training data (after 500 epochs) of 0.00015.

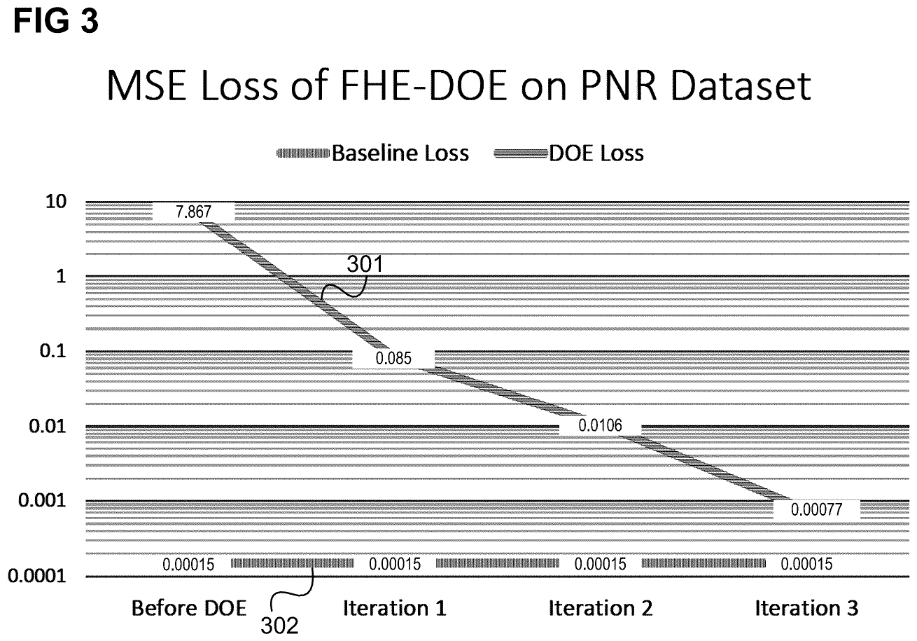

FIG. 3 shows the MSE Loss 301 for the inverse process (according to operation 108 of the process configuration procedure of FIG. 1) on encrypted data in comparison to a baseline loss 302. It demonstrates that the process can efficiently find the optimized inputs in as fast as three iterations.

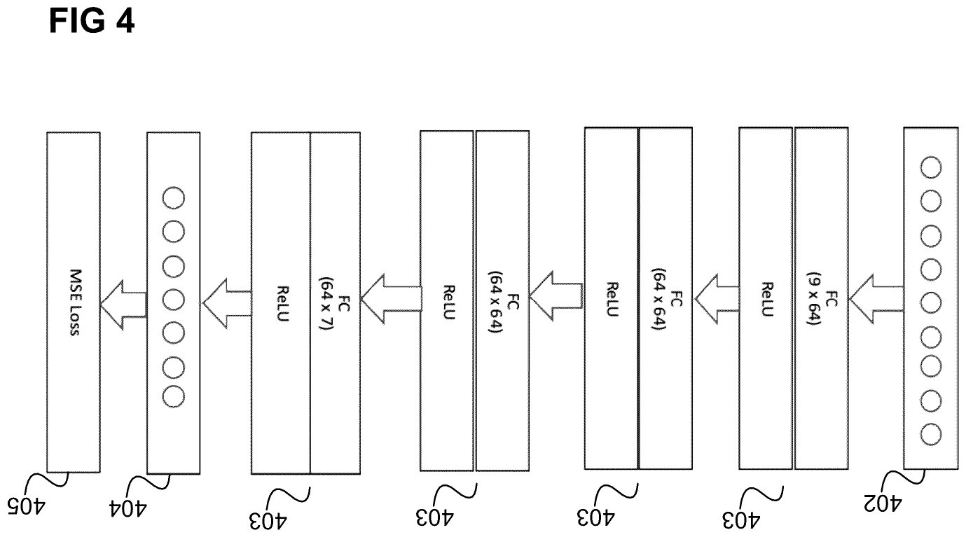

FIG. 4 shows another example of an architecture of the plaintext model 103.

An input 402 is processed by a sequence of fully connected layers 403, e.g. including ReLU activation, to an output 404.

The architecture may for example be trained using MSE (mean squared error) loss 405, e.g., for a semiconductor manufacturing application, using an op-AMP (operational amplifier) data set. Since the op-Amp dataset is relatively larger the model is in this case trained with the original activation functions.

Training of a model with the architecture of FIG. 2 for the op-AMP dataset gives an MSE Loss on the op-AMP dataset (after 6000 epochs) of 0.002.

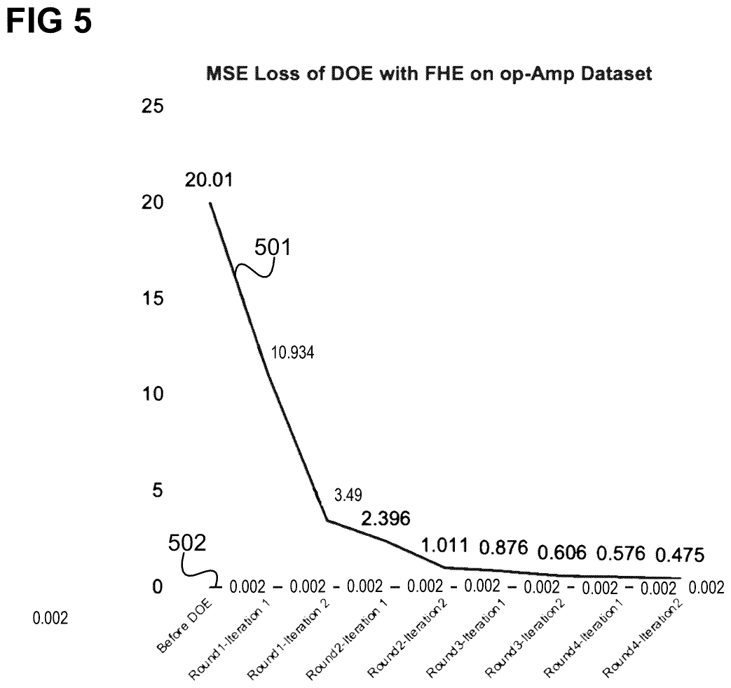

FIG. 5 shows the MSE Loss for the inverse process (according to operation 108 of the process configuration procedure of FIG. 1) on encrypted data (with polynomial approximated activation functions)) 501 in comparison to a baseline loss 502. It demonstrates that the process can efficiently find the optimized inputs in as fast as three iterations.

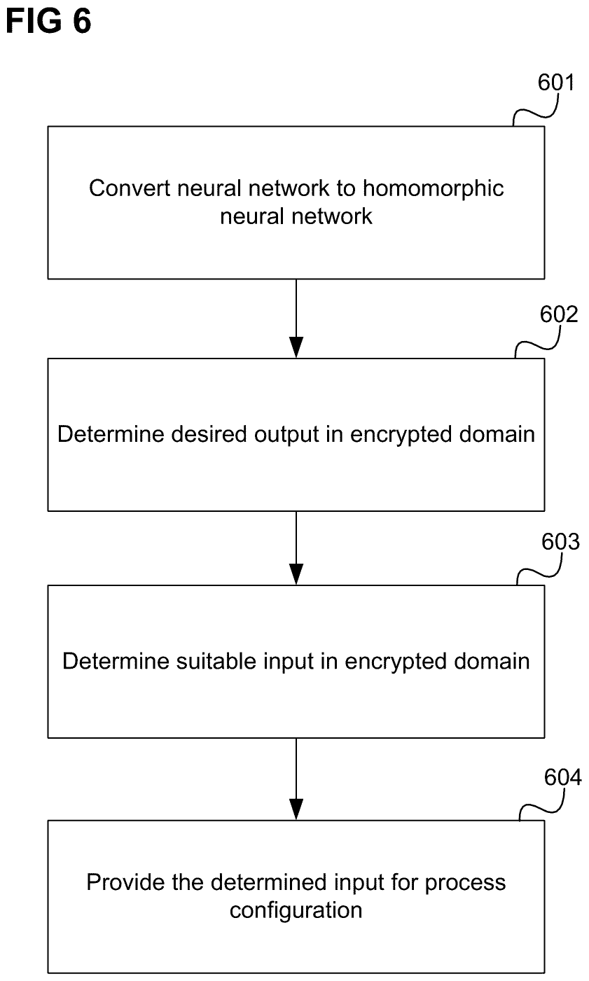

In summary, according to various embodiments, a method is provided as illustrated in FIG. 6.

FIG. 6 shows a flow diagram 600 illustrating a method for performing process configuration according to an embodiment.

In 601, a neural network trained to map process inputs to process outputs is converted to operate on data in encrypted domain of a predetermined encryption and decryption scheme such that the encryption of the encryption and decryption scheme is homomorphic with respect to the operation of the converted neural network.

In 602, a desired process output in encrypted domain is determined.

In 603, an input in encrypted domain to the converted neural network leading to an output of the converted neural network approximating the desired process output in encrypted domain is determined.

In 604, the determined input is provided for configuration of the process.

The approach of FIG. 6 enables a user to securely outsource a process configuration task to a service provider (denoted as designer above) without revealing the user's desired output to the service provider or the service providers process model(s) to the user. This avoids that the user needs to conduct lots of experiments to FIG. out an input for a desired process himself, which would be both time and resources consuming or that the user needs to give full control of his process to the designer, which would pose severe privacy concerns.

According to various embodiments, the approach of FIG. 6 is implemented using
a) A privacy preserving process configuration protocol for securely outsourced process configuration processes, which involves two parties—the designer who possesses a DL based process configuration model built from previous knowledge (available to the designer) and process datasets, and one or more users who want to obtain optimized inputs for certain desired outputs of the process from the designer's process configuration model. The protocol ensures no information leakage for both parties during the collaborated process configuration process.
b) A deep learning framework that extends the backward propagation process, which directly optimizes the inputs of the network with gradient descent, to minimize the loss between the network outputs and desired outputs.
c) A way to convert process configuration inverse process from plaintext domain to the HE cipher text domain, by utilizing polynomial approximations for computations of both the non-linear activation function computations and their gradients.

The approach of FIG. 6 may be applied to various applications where a process can be modelled by a neural network with certain inputs and outputs.

For example, it may be applied to various advanced manufacturing applications where the manufacturing processes are controlled by certain input configuration parameters for machines and/or tools, and different configurations generate different outputs (i.e. results). Process models can be built for the processes and the approach of FIG. 6 can be utilized for securely outsourcing the configuration process (i.e. the inverse process of finding a suitable input for a desired output).

It should be noted that the operations of FIG. 6 do not necessarily have to be carried out in the order shown but may also be at least partially be carried out in reversed order or in parallel. In particular, operations 601 and 602 may also be carried out in different order than the order shown.

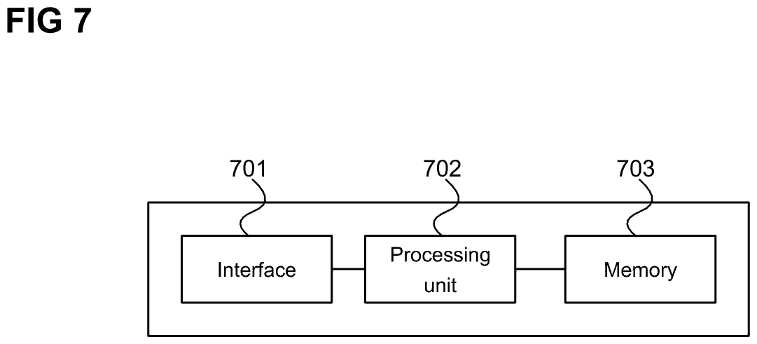

The method of FIG. 6 is for example carried out by a server computer as illustrated in FIG. 7.

FIG. 7 shows a server computer 700 according to an embodiment.

The server computer 700 includes a communication interface 701 (e.g. for communication with a client computer). The server computer 700 further includes a processing unit 702 and a memory 703. The memory 703 may be used by the processing unit 702 to store, for example, data to be processed, such as information about the neural network (i.e. its specification such as its weights). The server computer is configured to perform the method of FIG. 6. Operations carried out on the user side may accordingly be carried out on one or more client computers. Together, the client computer(s) and the server computer may form a system configured to perform the method according to various embodiments.

According to various embodiments, a method for performing Design of Experiments is provided including training a neural network to map experiment inputs to experiment outputs, converting the neural network to operate on data in encrypted domain of a predetermined encryption and decryption scheme such that the encryption of the encryption and decryption scheme is homomorphic with respect to the operation of the neural network, obtaining a desired experiment output, encrypting the desired experiment output to encrypted domain, determining an input in encrypted domain to the converted neural network leading to an output of the converted neural network approximating the encrypted desired experiment output and decrypting the determined input.

According to one embodiment, the input in encrypted domain to the converted neural network is determined by searching for an input which minimizes the loss between the output that the converted neural network outputs in response to the input and the encrypted desired experiment output.

According to one embodiment, the input is determined by performing back-propagation in the encrypted domain by utilizing polynomial approximations for computations of both the non-linear activation function computations and their gradients.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor, A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for configuring a process comprising:
converting a neural network trained to map process inputs to process outputs to operate on data in encrypted domain of a predetermined encryption and decryption scheme such that the encryption of the encryption and decryption scheme is homomorphic with respect to the operation of the converted neural network;
determining a desired process output in encrypted domain;
determining an input in encrypted domain to the converted neural network leading to an output of the converted neural network approximating the desired process output in encrypted domain; and
providing the determined input for configuration of the process.

2. The method of claim 1, comprising training the neural network to map process inputs to process outputs.

3. The method of claim 1, wherein determining the desired process output in encrypted domain comprises obtaining a desired process output and encrypting the desired process output to encrypted domain.

4. The method of claim 1, comprising decrypting the determined input.

5. The method of claim 4, comprising configuring the process according to the decrypted determined input.

6. The method according to claim 1, wherein the input in encrypted domain to the converted neural network is determined by searching for an input which minimizes the loss between the output that the converted neural network outputs in response to the input and the desired process output in encrypted domain.

7. The method according to claim 1, wherein the input in encrypted domain to the converted neural network is determined by performing back-propagation in the encrypted domain by utilizing polynomial approximations for computations of both the non-linear activation function computations and their gradients.

8. The method of claim 1, comprising controlling a system for performing the process according to the determined input.

9. The method of claim 1, wherein the process is a manufacturing process and the input specifies one or more control parameters of a manufacturing system and the method comprises controlling the manufacturing system according to the determined input.

10. The method of claim 1, wherein the encryption and decryption scheme is a public key encryption and decryption scheme, specifically, a levelled or fully homomorphic encryption scheme.

11. The method of claim 1, comprising performing multiple iterations of
determining a desired process output in encrypted domain; and
determining an input in encrypted domain to the converted neural network leading to an output of the converted neural network approximating the desired process output in encrypted domain;
until the determined input fulfils a predetermined quality criterion; and
providing the determined input for configuration of the process when the determined input fulfils the predetermined quality criterion.

12. The method of claim 11, wherein the predetermined quality criterion is that the determined input leads to an output of the converted neural network which approximates the desired process output in encrypted domain with a predetermined accuracy.

13. A system comprising one or more computers, each computer comprising a communication interface, a memory and a processing unit, wherein the system is configured to perform the method of claim 1.

14. A computer program element comprising program instructions, which, when executed by one or more processors, cause the one or more processors to perform the method of claim 1.

15. A computer-readable medium comprising program instructions, which, when executed by one or more processors, cause the one or more processors to perform the method of claim 1.
